(19) United States
(12) Patent Application Publication
(10) Pub. No.: US 2025/0329883 A1
(43) Pub. Date: Oct. 23, 2025

(54) POWER STORAGE MODULE

(71) Applicant: TOYOTA JIDOSHA KABUSHIKI KAISHA, Toyota-shi (JP)

(72) Inventors: Yusuke IKEDA, Miyoshi-shi (JP); Tetsuya Mimura, Chiryu-shi (JP); Tomofumi Hirukawa, Miyoshi-shi (JP); Hajime Hasegawa, Aichi-gun (JP); Shizuka Masuoka, Nagoya-shi (JP); Hiroki Awano, Susono-shi (JP); Kosuke Yonekawa, Nisshin-shi (JP); Jun Izumi, Toyota-shi (JP)

(73) Assignee: TOYOTA JIDOSHA KABUSHIKI KAISHA, Toyota-shi (JP)

(21) Appl. No.: 19/059,090

(22) Filed: Feb. 20, 2025

(30) Foreign Application Priority Data
Apr. 18, 2024 (JP) 2024-067540

(51) Int. Cl. H01M 50/477; H01M 10/0585; H01M 50/103; H01M 50/474

(52) U.S. Cl. CPC H01M 50/477; H01M 10/0585; H01M 50/103; H01M 50/474

(57) ABSTRACT

A power storage module includes: a stacked electrode assembly which includes a plurality of electrodes stacked in a first direction and is impregnated with an electrolyte solution; and a housing accommodating the stacked electrode assembly. The housing and the stacked electrode assembly extend in a second direction perpendicular to the first direction. The power storage module further includes a plate-like member extending in the second direction and disposed facing the stacked electrode assembly within the housing. The plate-like member is disposed so that a thickness direction of the plate-like member is a third direction perpendicular to the first direction and the second direction. The plate-like member has a facing surface facing the stacked electrode assembly. At least a portion of the facing surface is curved or distorted along the second direction. The facing surface being curved or distorted forms a space between the facing surface and the stacked electrode assembly.

### CROSS REFERENCE TO RELATED APPLICATIONS

This nonprovisional application is based on Japanese Patent Application No. 2024-067540 filed on Apr. 18, 2024 with the Japan Patent Office, the entire content of which is hereby incorporated by reference.

### BACKGROUND

### Field

The present disclosure relates to a power storage module.

### Description of the Background Art

Conventionally, a power storage module including a stacked structure, which is an electrode assembly, is known. Japanese Patent Laying-Open No. 2002-198099 discloses such a power storage module, which is a sheet lithium secondary battery including a stacked structure as an electricity generation element, the stacked structure including multiple units each unit comprising a positive sheet electrode and a negative sheet electrode superimposed one on the other with a separator or a solid-electrolyte layer in-between, wherein a tape is wrapped around the outer periphery of the stacked structure to tie and secure the sheet electrodes comprising the stacked structure with the tape. During the manufacturing of the sheet lithium secondary battery, since an electrolyte solution is impregnated into every corner of the stacked structure in a short period of time in the operation of impregnation of the electrolyte solution into the stacked structure, multiple through-holes are provided in a distributed fashion in portions of the tape covering the side surfaces of the stacked structure.

### SUMMARY

In the power storage module, in order to maintain the battery performance, there is a need to retain the electrolyte solution, impregnated in the stacked electrode assembly, within the stacked electrode assembly. The sheet lithium secondary battery disclosed in Japanese Patent Laying-Open No. 2002-198099 does not have a high performance (liquid retention performance) of retaining the electrolyte solution impregnated in the stacked electrode assembly (the stacked structure) within the stacked electrode assembly. Accordingly, an increase in liquid retention performance is desirable.

The present disclosure provides a power storage module which facilitates retaining, within the stacked electrode assembly, of the electrolyte solution impregnated in the stacked electrode assembly.

According to a certain aspect of the present disclosure, a power storage module includes: a stacked electrode assembly which includes a plurality of electrodes stacked in a first direction and is impregnated with an electrolyte solution; and a housing accommodating the stacked electrode assembly. The housing and the stacked electrode assembly extend in a second direction perpendicular to the first direction. The power storage module further includes a plate-like member extending in the second direction and disposed facing the stacked electrode assembly within the housing. The plate-like member is disposed so that a thickness direction of the plate-like member is a third direction perpendicular to the first direction and the second direction. The plate-like member has a facing surface facing the stacked electrode assembly. At least a portion of the facing surface is curved or distorted along the second direction. The facing surface being curved or distorted forms a space between the facing surface and the stacked electrode assembly.

With such a configuration, the electrolyte solution can be retained in a space between the stacked electrode assembly and the facing surface. Thus, the supply of the electrolyte solution to the stacked electrode assembly is facilitated. Accordingly, the power storage module is more facilitated to retain the electrolyte solution, impregnated in the stacked electrode assembly, within the stacked electrode assembly, as compared to without the plate-like member.

Preferably, the plate-like member has a middle portion and opposing end portions in the second direction. The middle portion is thinner than the opposing end portions.

In general, the electrolyte solution tends to retain less at the middle portion of the stacked electrode assembly in the second direction than at the opposing end portions in the second direction. An event is likely to occur in which the electrolyte solution travels from the middle portion of the stacked electrode assembly in the second direction to around the middle portion. Thus, like the above configuration, the middle portion of the plate-like member is made thinner than the opposing end portions to facilitate the supply of the electrolyte solution to the middle portions of the stacked electrode assembly in the second direction. Thus, improved liquid retention performance of the electrolyte solution is achieved at the middle portions of the stacked electrode assembly in the second direction.

Preferably, a plurality of through-holes, passing through in the third direction, are formed in the plate-like member at different locations in the second direction. With such a configuration, the supply of the electrolyte solution to the stacked electrode assembly is facilitated at the injection, as compared to without the through-holes. Furthermore, since the electrolyte solution is accumulated in the through-holes even after the injection, the supply of the electrolyte solution into the stacked electrode assembly is facilitated. Due to this, enhanced liquid retention performance of the electrolyte solution in the stacked electrode assembly is achieved.

Preferably, among the plurality of through-holes, a first through-hole closer to the middle portion than one of the opposing end portions has a greater open area than a second through-hole closer to the one of the opposing end portions than the middle portion.

With such a configuration, the supply of the electrolyte solution to the middle portion of the stacked electrode assembly in the second direction is facilitated at the injection. Furthermore, since the electrolyte solution is accumulated in the through-holes even after the injection, improved liquid retention performance of the electrolyte solution is achieved at the middle portions of the stacked electrode assembly in the second direction.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a power storage module.

FIG. 2 is a diagram showing a stacked electrode assembly included in the power storage module of FIG. 1.

FIG. 3 is a cross-sectional arrow view of the power storage module, taken along a III-III line of FIG. 1.

FIG. 4 is a diagram of a plate-like member as viewed in the orientation indicated by an arrow IV of FIG. 3.

FIG. 5 is a diagram of the plate-like member of FIG. 4, as viewed from above.

### DESCRIPTION OF THE PREFERRED EMBODIMENTS

Hereinafter, an embodiment according to the present disclosure will be described, with reference to the accompanying drawings. Note that the embodiment below uses the same reference signs to refer to the same or common parts, and description thereof will not be repeated.

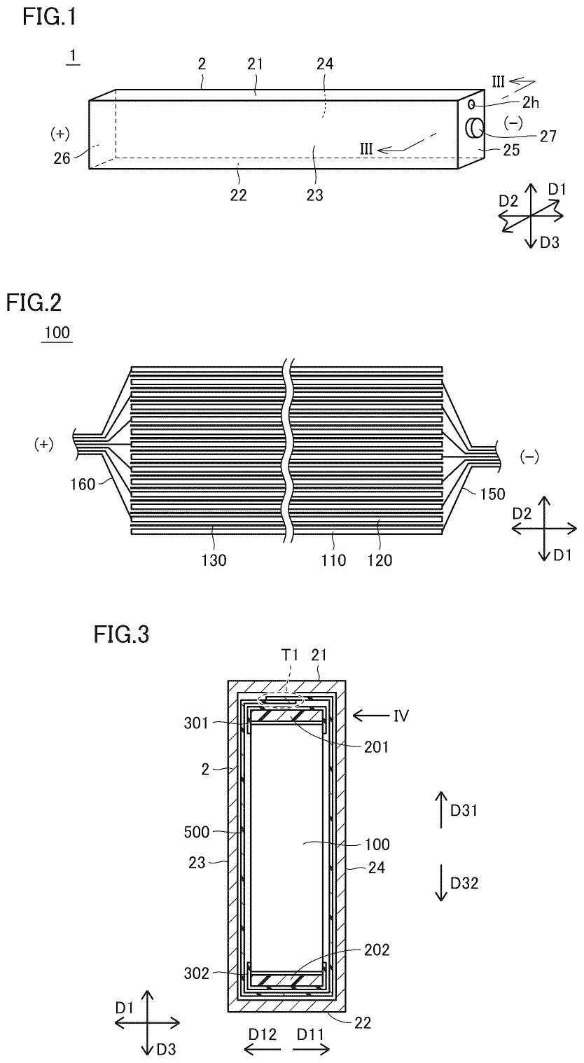

FIG. 1 is a perspective view of a power storage module according to the present embodiment. FIG. 2 is a diagram showing a stacked electrode assembly included in the power storage module of FIG. 1. As shown in FIGS. 1 and 2, a power storage module 1 has a blade shape. Power storage module 1 includes a stacked electrode assembly 100 and a housing 2 accommodating stacked electrode assembly 100. Note that, in the following, for convenience of illustration, power storage module 1 will be described, with reference to an example in which the power storage module 1 is oriented so that a D3 direction shown in FIGS. 1, 2, etc. is the vertical direction (more specifically, the orientation of D31 described below is vertically upward), except when an electrolyte solution is injected, which will be described below.

Power storage module 1 is, in this example, a lithium iron phosphate (LFP) battery. However, the present disclosure is not limited thereto. Power storage module 1 may be a nickel manganese cobalt (NMC) battery. Power storage module 1 is mounted on, for example, a battery electric vehicle traveling with a driving force obtained from electrical energy. Specifically, a battery pack, including multiple power storage modules 1 aligned in a predetermined direction, is mounted on a battery electric vehicle. The battery pack is mounted on the vehicle body of the battery electric vehicle. The battery pack constitutes a part of the vehicle body. The battery pack serves as the structure of the vehicle body.

As shown in FIG. 1, housing 2 has a generally cuboid shape. Housing 2, in this example, is made of metal. Housing 2 has first to sixth surfaces 21 to 26. A first surface 21, a second surface 22, a third surface 23, and a fourth surface 24 continue in the listed order. First surface 21, second surface 22, third surface 23, and fourth surface 24 constitute the outer circumferential surface of housing 2.

A fifth surface 25 and a sixth surface 26 are end surfaces of housing 2. First surface 21 is the top surface, second surface 22 is the bottom surface, and third surface 23 and fourth surface 24 are side surfaces. A negative-side external connection terminal 27 is disposed on fifth surface 25. A positive-side external connection terminal (not shown) is disposed on sixth surface 26.

D1 direction is the width direction of power storage module 1. As shown in FIG. 2, stacked electrode assembly 100 includes multiple electrodes stacked in D1 direction (a laminate direction). Specifically, in stacked electrode assembly 100, a negative electrode 110 and a positive electrode 120 are stacked in D1 direction with a separator 130 in-between. Stacked electrode assembly 100 further includes tabs 150 connected to negative-side external connection terminal 27 and tabs 160 connected to the positive-side external connection terminal. Tab 150 is a collection of copper foils. Tab 160 is a collection of aluminum foils.

As shown in 1, power storage module 1 and housing 2 extend in D2 direction. As shown in 2, stacked electrode assembly 100 has a generally cuboid shape. Stacked electrode assembly 100 extends in D2 direction. D2 direction is perpendicular to D1 direction. D2 direction is the longitudinal directions of power storage module 1, housing 2, and stacked electrode assembly 100. D3 direction is perpendicular to D1 direction and D2 direction. D3 direction is the height direction of power storage module 1.

D1 direction is the lateral directions of first surface 21, second surface 22, fifth surface 25, and sixth surface 26. D2 direction is the longitudinal directions of first to fourth surfaces 21 to 24. D3 direction is the lateral directions of third and fourth surfaces 23 and 24 and the longitudinal directions of fifth and sixth surfaces 25 and 26.

An injection hole 2h is formed in fifth surface 25 for injecting an electrolyte solution into housing 2. Injection hole 2h is formed closer to first surface 21 of housing 2 than second surface 22. Injection hole 2h is formed closer to first surface 21 than external connection terminal 27. Note that in FIG. 1, since the electrolyte solution is already injected inside the housing 2, injection hole 2h is sealed. Injection hole 2h may be temporarily sealed by inserting a detachable stopper into injection hole 2h. Alternatively, injection hole 2h may be sealed with a resin or a metal so that no electrolyte solution can be injected into housing 2 again, unless the through-hole is opened.

When the electrolyte solution is injected into housing 2 through injection hole 2h, for example, during the manufacturing of power storage module 1, the orientation of power storage module 1 is kept so that D2 direction is substantially the vertical direction and fifth surface 25 is located above the sixth surface 26. Due to the self-weight of the electrolyte solution, the electrolyte solution flows from the fifth surface 25 side to the sixth surface 26 side. Note that the electrolyte solution, since it has a certain degree of viscosity, falls within housing 2 at a slow speed. This allow the electrolyte solution to be impregnated into stacked electrode assembly 100.

In this example, injection hole 2h is formed closer to first surface 21 than external connection terminal 27. However, the present disclosure is not limited thereto. Injection hole 2h may be formed closer to second surface 22 than external connection terminal 27. Injection hole 2h may be formed closer to third surface 23 than external connection terminal 27. Injection hole 2h may be formed closer to fourth surface 24 than external connection terminal 27.

Further in this example, injection hole 2h is formed in fifth surface 25. However, the present disclosure is not limited thereto. For example, injection hole 2h may be formed in sixth surface 26. Injection hole 2h may be formed in first surface 21 or second surface 22. When injection hole 2h is formed in first surface 21 or second surface 22, preferably, injection hole 2h is formed closer to the end side (the fifth surface 25 side or the sixth surface 26 side) of housing 2 in the longitudinal direction than the middle portion from the standpoint of liquid injection property. Injection hole 2h may be formed in third surface 23 or fourth surface 24. The location of formation of injection hole 2h is not particularly limited.

As noted above, power storage module 1 has the blade shape. Thus, housing 2 has a blade shape too. Stacked electrode assembly 100 accommodated in housing 2 has a blade shape too. Thus, the lengths of housing 2, negative electrode 110, and positive electrode 120 in D3 direction are longer than the lengths of housing 2, negative electrode 110, and positive electrode 120 in D1 direction. Furthermore, the lengths of housing 2, negative electrode 110, and positive electrode 120 in D2 direction are longer than the lengths of the housing, negative electrode 110, and positive electrode 120 in D3 direction.

The length of housing 2 in D3 direction is, by way of example, six or seven times the length of housing 2 in D1 direction. The length of housing 2 in D2 direction is, by way of example, ten to eleven times the length of housing 2 in D3 direction. However, the ratio between the length of housing 2 in D1 direction and the length of housing 2 in D2 direction and the length of housing 2 in D3 direction is not limited thereto.

FIG. 3 is a cross-sectional arrow view of power storage module 1, taken along a III-III line of FIG. 1. As shown in 3, power storage module 1 further includes plate-like members 201 and 202, tape materials 301 and 302, and an insulating sheet 500, in addition to housing 2 and stacked electrode assembly 100.

Plate-like members 201 and 202, tape materials 301 and 302, and insulating sheet 500 are accommodated in housing 2, as with stacked electrode assembly 100. Plate-like members 201 and 202, tape materials 301 and 302, and insulating sheet 500 are disposed (in a gap) between stacked electrode assembly 100 and housing 2.

Plate-like members 201 and 202 are insulators. In this example, plate-like members 201 and 202 are each formed of a resin. Plate-like members 201 and 202 are, in this example, each formed of an insulative material from the standpoint of prevention of a short circuit between positive electrode 120 and negative electrode 110 of stacked electrode assembly 100. Note that if an insulating distance is sufficiently secured between stacked electrode assembly 100 and plate-like members 201 and 202, plate-like members 201 and 202 may not necessarily be insulators.

For example, polypropylene is used as a material constituting plate-like members 201 and 202. However, the present disclosure is not limited thereto. For example, polyethylene, polyphenylene sulfide, poly ether ether ketone, or polyethylene terephthalate (PET) may be used.

Plate-like member 201 is disposed facing the stacked electrode assembly 100, within housing 2. Plate-like member 201 is disposed above the stacked electrode assembly 100. Specifically, plate-like member 201 is disposed directly above the stacked electrode assembly 100. Plate-like member 201 is placed on the first surface 21 side of housing 2. Plate-like member 201 is placed in the orientation of D31 of D3 direction, relative to stacked electrode assembly 100. Note that the orientation of D31 is vertically upward, as noted above.

As with plate-like member 201, plate-like member 202 is disposed facing the stacked electrode assembly 100, within housing 2. Plate-like member 202 is disposed below the stacked electrode assembly 100. Specifically, plate-like member 202 is disposed directly below the stacked electrode assembly 100. Plate-like member 202 is placed on the second surface 22 side of housing 2. Plate-like member 202 is placed in the orientation of D32 of D3 direction, relative to stacked electrode assembly 100. Note that the orientation of D32 is vertically downward.

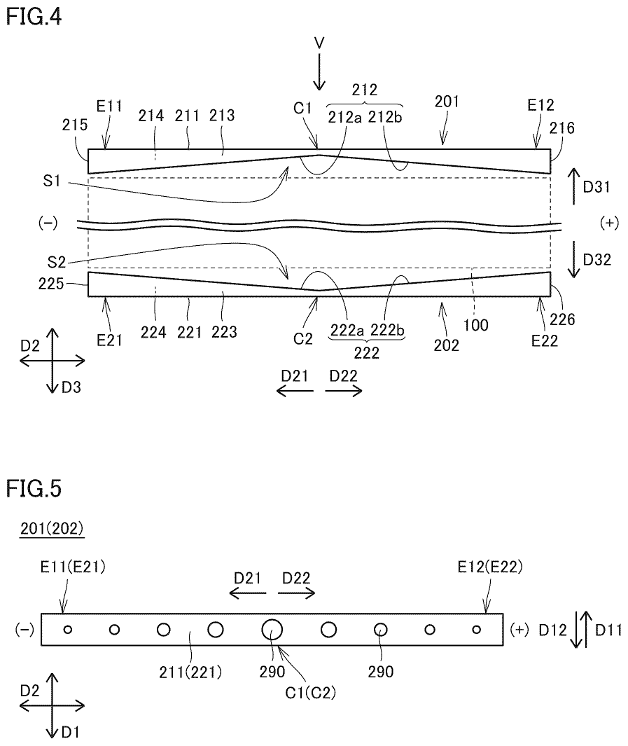

FIG. 4 is a diagram of plate-like members 201 and 202 as viewed in the direction indicated by an arrow IV of FIG. 3. FIG. 4 is a side view of plate-like members 201 and 202. As shown in 4, plate-like members 201 and 202 extend in D2 direction. Plate-like members 201 and 202 are disposed within housing 2 so that the thickness directions of plate-like members 201 and 202 are D3 direction.

Plate-like member 201 has a middle portion C1 in D2 direction and the opposing end portions E11 and E12 in D2 direction. End portion E11 is on the external connection terminal 27 side of FIG. 1. End portion E12 is opposite the end portion E11. Middle portion C1 and the opposing end portions E11 and E12 differ in thickness. In the example of FIG. 4, middle portion C1 is thinner than the opposing end portions E11 and E12.

Plate-like member 201 further has first to sixth surfaces 211 to 216. A first surface 211 is on the first surface 21 side of housing 2. First surface 211 is a surface opposite the stacked electrode assembly 100. In this example, first surface 211 is a flat surface. In FIGS. 3 and 4, first surface 211 is the top surface. First surface 211 is in parallel to stacked electrode assembly 100.

A second surface 212 is on stacked electrode assembly 100 side. In FIGS. 3 and 4, second surface 212 is the bottom surface. Second surface 212 is a facing surface facing the stacked electrode assembly 100. Second surface 212 is curved along D2 direction. In this example, second surface 212 is curved at middle portion C1. Second surface 212 recedes in the orientation of D31. Specifically, in this example, second surface 212 includes a slope surface 212a and a slope surface 212b. Specifically, second surface 212 includes, along D2 direction, a region in which the separation distance between second surface 212 and stacked electrode assembly 100 is less than or equal to a reference value (length) across D1 direction, and a region in which the separation distance is longer than the reference value across D1 direction.

In this example, slope surface 212a and slope surface 212b are flat surfaces. Slope surface 212a and slope surface 212b are sloped along D2 direction. Slope surface 212a and slope surface 212b are sloped so that the middle portion C1 of plate-like member 201 is thinner than the opposing end portions E11 and E12. This forms a space S1 accommodating the electrolyte solution, between stacked electrode assembly 100 and slope surfaces 212a and 212b.

As noted above, since first surface 211 is in parallel to stacked electrode assembly 100, the thickness of plate-like member 201 gradually decreases toward middle portion C1 due to slope surfaces 212a and 212b. Due to slope surfaces 212a and 212b, plate-like member 201 has a portion having a thickness greater than a predetermined thickness and a portion having a thickness less than or equal to the predetermined thickness.

A third surface 213 is on the third surface 23 side of housing 2. A fourth surface 214 is on the fourth surface 24 side of housing 2. Third surface 213 and fourth surface 214 are side surfaces of plate-like member 201. A fifth surface 215 is an end surface on the end portion E11 side. A sixth surface 216 is an end surface on the end portion E12 side.

Plate-like member 202 has a middle portion C2 in D2 direction and opposing end portions E21 and E22 in D2 direction. End portion E21 is on the external connection terminal 27 side of FIG. 1. End portion E22 is opposite the end portion E11. Middle portion C2 and the opposing end portions E21 and E22 differ in thickness. In the example of FIG. 4, middle portion C2 is thinner than the opposing end portions E21 and E22.

Plate-like member 202 further has first to sixth surfaces 221 to 226. A first surface 221 is on the second surface 22 side of housing 2. First surface 221 is a surface opposite the stacked electrode assembly 100. In this example, first surface 221 is a flat surface. In FIGS. 3 and 4, first surface 221 is the bottom surface. First surface 221 is in parallel to stacked electrode assembly 100.

A second surface 222 is on the stacked electrode assembly 100 side. In FIGS. 3 and 4, second surface 222 is the top surface. Second surface 222 is a facing surface facing the stacked electrode assembly 100. Second surface 222 is curved along D2 direction. In this example, second surface 212 is curved at middle portion C1. Second surface 222 recedes in the orientation of D32. Specifically, in this example, second surface 222 includes a slope surface 222a and a slope surface 222b.

Specifically, similarly to second surface 212 of plate-like member 201, second surface 222 includes, along D2 direction, a region in which the separation distance between second surface 222 and stacked electrode assembly 100 is less than or equal to a reference value across D1 direction, and a region in which the separation distance is longer than the reference value.

In this example, slope surface 222a and slope surface 222b are flat surfaces. Slope surface 222a and slope surface 222b are sloped along D2 direction. Slope surface 222a and slope surface 222b are sloped so that middle portion C2 of plate-like member 202 is thinner than the opposing end portions E21 and E22. This forms a space S2 accommodating the electrolyte solution, between stacked electrode assembly 100 and slope surfaces 222a and 222b.

As noted above, since first surface 221 is in parallel to stacked electrode assembly 100, the thickness of plate-like member 202 gradually decreases toward middle portion C2 due to slope surfaces 222a and 222b. Due to slope surfaces 222a and 222b, plate-like member 202 has a portion having a thickness greater than a reference thickness and a portion having a thickness less than or equal to the reference thickness.

A third surface 223 is on the third surface 23 side of housing 2. A fourth surface 224 is on the fourth surface 24 side of housing 2. Third surface 223 and fourth surface 224 are side surfaces of plate-like member 202. A fifth surface 225 is an end surface on the end portion E21 side. A sixth surface 226 is an end surface on the end portion E22 side.

In this example, plate-like member 202 and plate-like member 201 have shapes that are symmetrical about stacked electrode assembly 100. However, the present disclosure is not limited thereto.

As shown in 3, plate-like member 201 is secured to stacked electrode assembly 100 by a tape material 301. Tape material 301 extends in D2 direction. Tape material 301 covers all or part of first surface 211 of plate-like member 201. Tape material 301 covers all or part of third and fourth surfaces 213 and 214 of plate-like member 201. Tape material 301 covers part of stacked electrode assembly 100.

Plate-like member 202 is secured to stacked electrode assembly 100 by a tape material 302. Tape material 302 extends in D2 direction. Tape material 302 covers all or part of first surface 221 of plate-like member 202. Tape material 302 covers all or part of third and fourth surfaces 223 and 224 of plate-like member 202. Tape material 302 covers part of stacked electrode assembly 100.

Insulating sheet 500 insulates stacked electrode assembly 100 and housing 2 from each other. Insulating sheet 500 covers stacked electrode assembly 100 to prevent stacked electrode assembly 100 from touching housing 2. Insulating sheet 500 is provided between stacked electrode assembly 100 and housing 2 (specifically, the inner surface of the housing) to prevent a short circuit of stacked electrode assembly 100.

Specifically, insulating sheet 500 covers plate-like members 201 and 202. Insulating sheet 500 covers plate-like member 201 via tape material 301. Similarly, insulating sheet 500 covers plate-like member 202 via tape material 302.

The opposing end portions of insulating sheet 500 are welded together. Insulating sheet 500 is wrapped around tape materials 301 and 302, plate-like members 201 and 202, and stacked electrode assembly 100, while plate-like members 201 and 202 are secured to stacked electrode assembly 100 by tape materials 301 and 302. Subsequently, the opposing end portions of insulating sheet 500 are welded together, and insulating sheet 500 of FIG. 3 is, thereby, obtained. The opposing end portions of insulating sheet 500 overlap in a welded region T. Welded region T extends in D2 direction. Note that multiple insulating sheets may be coupled together to form insulating sheet 500.

Note that as a material constituting insulating sheet 500, for example, polypropylene is used. However, the present disclosure is not limited thereto. For example, polyethylene, polyphenylene sulfide, poly ether ether ketone, nylon, or polyethylene terephthalate (PET) may be used.

FIG. 5 is a diagram showing plate-like member 201 of FIG. 4, as viewed in the orientation indicated by arrow V. FIG. 5 is a diagram showing plate-like member 201 of FIG. 4 as viewed from above.

As shown in FIG. 5, multiple through-holes 290, passing therethrough in D3 direction, are formed in plate-like member 201 at different locations in D2 direction. Specifically, through-holes 290 are formed in plate-like member 201, from first surface 211 through second surface 212, which is the undersurface of first surface 211. Through-holes 290 are aligned in D2 direction. However, the present disclosure is not limited thereto. Through-holes 290 may be alighted in several lines in D2 direction.

In this example, among through-holes 290, a through-hole 290 closer to middle portion C1 than end portion E11 (or end portion E12) has a greater open area than a through-hole 290 closer to end portion E11 (or end portion E12) than middle portion C1. Specifically, through-holes 290 have increasing open areas from the opposing end portions E11 and E12 toward middle portion C1. This is to facilitate the supply of the electrolyte solution to the middle portion of stacked electrode assembly 100 in D2 direction. Note that the present disclosure is not limited thereto, and through-holes 290 may have the same open area.

The separation distances between the respective through-holes 290 may be constant or different. When through-holes 290 have the same open area, preferably, more through-holes 290 are formed on the middle portion C1 side than the opposing end portions E11 and E12 sides from the standpoint of facilitating the supply of the electrolyte solution to the middle portion of stacked electrode assembly 100 in D2 direction.

Similarly to plate-like member 201, plate-like member 202 have multiple through-holes 290. In this example, plate-like member 202 has the same configuration as plate-like member 201. Thus, here, the description of through-holes 290 in plate-like member 202 will not be repeated.

### SUMMARY

(1) As shown in FIGS. 1 and 2, power storage module 1 includes: stacked electrode assembly 100 which includes multiple electrodes stacked in D1 direction and is impregnated with an electrolyte solution; and housing 2 accommodating stacked electrode assembly 100. Housing 2 and stacked electrode assembly 100 extend in D2 direction perpendicular to D1 direction. As shown in FIGS. 3 and 4, power storage module 1 further includes plate-like members 201 and 202 which are extending in D2 direction and disposed facing the stacked electrode assembly 100 within housing 2.

Plate-like members 201 and 202 are disposed that the thickness directions of plate-like members 201 and 202 are D3 direction perpendicular to D1 direction and D2 direction. As shown in FIG. 4, plate-like members 201 and 202 have second surfaces 212 and 222 facing the stacked electrode assembly 100. Second surfaces 212 and 222 are curved along D2 direction. Second surfaces 212 and 222 being curved forms spaces S1 and S2 between second surfaces 212 and 222 and stacked electrode assembly 100.

With such a configuration, the electrolyte solution can be retained in spaces S1 and S2 (gaps) between stacked electrode assembly 100 and second surfaces 212 and 222. Thus, the supply of the electrolyte solution to stacked electrode assembly 100 is facilitated. Accordingly, power storage module 1 is more facilitated to retain the electrolyte solution, impregnated in stacked electrode assembly 100, within stacked electrode assembly 100, as compared to without plate-like members 201 and 202.

(2) As shown in FIG. 4, plate-like member 201 has middle portion C1 and the opposing end portions E11 and E12 in D2 direction. Plate-like member 202 has middle portion C2 and the opposing end portions E21 and E22 in D2 direction. Middle portion C1 is thinner than the opposing end portions E11 and E12. Middle portion C2 is thinner than the opposing end portions E21 and E22.

The electrolyte solution is difficult to retain at the middle portion of stacked electrode assembly 100 in D2 direction, as compared to at the opposing end portions in D2 direction. An event is likely to occur in which the electrolyte solution travels from the middle portion of stacked electrode assembly 100 in D2 direction to around the middle portion. Thus, like the above configuration, middle portions C1 and C2 of plate-like members 201 and 202 are made thinner than the opposing end portions E11 and E12, E21, and E22 to facilitate the supply of the electrolyte solution to the middle portions of stacked electrode assembly 100. Thus, improved liquid retention performance of the electrolyte solution is achieved at the middle portions of stacked electrode assembly 100.

(3) Through-holes 290 are formed in plate-like members 201 and 202 at different locations in D2 direction, passing through the plate-like members 201 and 202 in D3 direction. With such a configuration, the supply of the electrolyte solution to stacked electrode assembly 100 is facilitated at the injection, as compared to without through-holes 290. Furthermore, since the electrolyte solution is accumulated in through-holes 290 even after the injection, the supply of the electrolyte solution into stacked electrode assembly 100 is facilitated. Due to this, enhanced liquid retention performance of the electrolyte solution in stacked electrode assembly 100 is achieved.

(4) Among through-holes 290, a through-hole 290 closer to middle portion C1 than end portion E11 (or end portion E12) has a greater open area than a through-hole 290 closer to end portion E11 (or end portion E12) than middle portion C1. With such a configuration, the supply of the electrolyte solution to the middle portion of stacked electrode assembly 100 in D2 direction is facilitated at the injection. Furthermore, since the electrolyte solution is accumulated in through-holes 290 even after the injection, improved liquid retention performance of the electrolyte solution is achieved at the middle portions of stacked electrode assembly 100.

(5) The lengths of housing 2 and the electrodes (negative electrode 110 and positive electrode 120) in D3 direction are longer than the lengths of housing 2 and the electrodes in D1 direction. The lengths of housing 2 and the electrodes in D2 direction are longer than the lengths of housing 2 and the electrodes in D3 direction. As shown in FIG. 1, housing 2 has fifth surface 25 on the D2 direction side. External connection terminal 27 is formed on fifth surface 25. External connection terminal 27 is electrically connected to stacked electrode assembly 100.

With such a configuration, the length in D2 direction is the longest of the lengths of power storage module 1 in D1 direction, D2 direction, and D3 direction. In general, the power storage module having such a shape tends to have poor liquid injection property in D2 direction, which is the longitudinal direction of power storage module 1. However, according to power storage module 1, the electrolyte solution can be supplied to stacked electrode assembly 100 through through-holes 290 and spaces S1 and S2 formed between stacked electrode assembly 100 and plate-like members 201 and 202. Thus, according to power storage module 1, enhanced liquid injection property and liquid retention property of the electrolyte solution in stacked electrode assembly 100 can be achieved even if the length of power storage module 1 in D2 direction is the longest of the lengths of power storage module 1 in D1 direction, D2 direction, and D3 direction.

### <Variations>

### (1) Variation 1

In the above, middle portions C1 and C2 of plate-like members 201 and 202 are thinner than the opposing end portions E11, E12, E21, and E22 of the plate-like members 201 and 202. However, the present disclosure is not limited thereto. middle portions C1 and C2 of plate-like members 201 and 202 may be thicker than the opposing end portions E11, E12, E21, and E22. For such a configuration, a gas produced within stacked electrode assembly 100 through charging and discharging can be easily discharged from stacked electrode assembly 100 from the opposing end portions E11, E12, E21, and E22. In other words, the gas discharge property is excellent. The liquid injection property of the electrolyte solution through the opposing end portions E11, E12, E21, and E22 and the liquid retention property are excellent too.

### (2) Variation 2

In the above, through-holes 290 have increasing open areas from the opposing end portions E11 and E12 toward middle portion C1. However, the present disclosure is not limited thereto. Plate-like members 201 and 202 may be configured so that the through-holes 290 have increasing open areas from the opposing end portions E11 and E12 toward middle portion C1. For such a configuration, a gas produced within stacked electrode assembly 100 through charging and discharging can be easily discharged through the through-holes formed in the opposing end portions E11, E12, E21, and E22. In other words, the gas discharge property is excellent.

### (3) Variation 3

In the above, second surface 212 of plate-like member 201 is configured of two flat surfaces (slope surfaces 212a and 212b). Second surface 222 of plate-like member 202 is configured of two flat surfaces (slope surfaces 222a and 222b) too. However, the present disclosure is not limited thereto. Second surface 212 of plate-like member 201 may be configured of three or more flat surfaces, one or more curved surfaces, or a combination thereof.

Specifically, at least a portion of second surface 212 may be curved or distorted along D2 direction. Second surface 212 does not need to be curved or distorted entirely along D2 direction. At least a portion of second surface 212 may be curved or distorted. Note that being curved or distorted includes a portion of plate-like member 201 (e.g., middle portions C1 and C2 or the end portions E11, E12, E21, and E22) as being cut out from the second surface 212 side. In this regard, the same goes for second surface 222 of plate-like member 202.

### (4) Variation 4

In the above, through-holes 290 are formed in plate-like members 201 and 202. However, the present disclosure is not limited thereto. Non-penetrating holes may be formed in plate-like members 201 and 202, instead of the multiple through-holes 290. When plate-like members 201 and 202 are disposed as shown in FIG. 4, preferably, multiple holes are formed in second surfaces 212 and 222 facing the stacked electrode assembly 100 from the standpoint of the supply of the electrolyte solution to stacked electrode assembly 100. The holes may be located in the same manner as through-holes 290 are located, for example.

### (5) Variation 5

In the above, through-holes 290 are formed in plate-like members 201 and 202. However, the present disclosure is not limited thereto. One through-hole 290 may be formed in each of plate-like members 201 and 202. In this case, preferably, through-hole 290 is formed at or around middle portions C1 and C2 of plate-like members 201 and 202 in D2 direction. The same goes for the case where a non-penetrating hole is formed, instead of through-hole 290.

While the embodiments according to the present disclosure has been described above, the presently disclosed embodiments should be considered in all aspects illustrative and not restrictive. The scope of the present disclosure is defined by the appended claims. All changes which come within the meaning and range of equivalency of the appended claims are to be embraced within their scope.

What is claimed is:

1. A power storage module, comprising:
a stacked electrode assembly which includes a plurality of electrodes stacked in a first direction and is impregnated with an electrolyte solution; and
a housing accommodating the stacked electrode assembly, wherein
the housing and the stacked electrode assembly extend in a second direction perpendicular to the first direction,
the power storage module further includes a plate-like member extending in the second direction and disposed facing the stacked electrode assembly within the housing, wherein
the plate-like member is disposed so that a thickness direction of the plate-like member is a third direction perpendicular to the first direction and the second direction,
the plate-like member has a facing surface facing the stacked electrode assembly,
at least a portion of the facing surface is curved or distorted along the second direction, and
the facing surface being curved or distorted forms a space between the facing surface and the stacked electrode assembly.

2. The power storage module according to claim 1, wherein
the plate-like member has a middle portion and opposing end portions in the second direction, and
the middle portion is thinner than the opposing end portions.

3. The power storage module according to claim 1, wherein
a plurality of through-holes, passing through in the third direction, are formed in the plate-like member at different locations in the second direction.

4. The power storage module according to claim 3, wherein
among the plurality of through-holes, a first through-hole closer to the middle portion than one of the opposing end portions has a greater open area than a second through-hole closer to the one of the opposing end portions than the middle portion.
